(19) United States
(12) Patent Application Publication
(10) Pub. No.: US 2008/0069748 A1
(43) Pub. Date: Mar. 20, 2008

(54) MULTIVALENT IRON ION SEPARATION IN METAL RECOVERY CIRCUITS

(75) Inventors: Larry A. Lien, Solana Beach, CA (US); Jay Lombardi, Boulder, CO (US); Jim Tranquilla, New Brunswick (CA)

Correspondence Address: SHERIDAN ROSS PC, 1560 BROADWAY, SUITE 1200, DENVER, CO, 80202, US

(73) Assignee: HW ADVANCED TECHNOLOGIES, INC., Lakewood, CO (US)

(21) Appl. No.: 11/858,485

(22) Filed: Sep. 20, 2007

Related U.S. Application Data
(60) Provisional application No. 60/826,311, filed on Sep. 20, 2006.

(51) Int. Cl. C01G 49/04; C01G 49/06

(52) U.S. Cl. 423/150.1

(57) ABSTRACT

The present invention is directed to the selective removal of ferric ion and/or ferric compounds from valuable metal recovery process streams.

### CROSS REFERENCE TO RELATED APPLICATION

The present application claims the benefits of U.S. Provisional Application Ser. No. 60/826,311, filed Sep. 20, 2006, entitled “Multivalent Ion Separation Using Chemical Complexation in Conjunction with Selective Membranes”, which is incorporated herein by this reference in its entirety.

### FIELD OF THE INVENTION

The invention relates generally to valuable metal recovery processes and particularly to controlling iron ion concentration in streams of metal recovery processes.

### BACKGROUND OF THE INVENTION

Valuable metals, such as base and precious metals, commonly are associated with sulfide minerals, such as iron pyrite, arsenopyrite, and chalcopyrite. Removal of valuable metals from sulfide materials requires oxidation of the sulfide matrix. This can be done using chemical oxidation (e.g., pressure oxidation) or biological oxidation (e.g., bio-oxidation) techniques. In the former technique, sulfide sulfur is oxidized at elevated temperatures and pressures into sulfate sulfur. This reaction can be autogeneous when an adequate level of sulfide sulfur (typically at least about 6.5 wt. %) is present. In the latter technique, sulfide sulfur is oxidized by bacteria into sulfate sulfur. Suitable bacteria include organisms, such as Thiobacillus Ferrooxidans; Thiobacillus Thiooxidans; Thiobacillus Organoparus; Thiobacillus Acidphilus; Sulfobacillus Thermosulfidooxidans; Sulfolobus Acidocaldarius, Sulfolobus BC; Sulfolobus Solfataricus; Acidanus Brierley; Leptospirillum Ferrooxidans; and the like for oxidizing the sulfide sulfur and other elements in the feed material. In this process, the valuable metal-containing material is formed into a heap and contacted with a lixiviant including sulfuric acid and nutrients for the organisms. The lixiviant is collected from the bottom of the heap and recycled.

Ferric ion, a byproduct of both types of oxidation processes, can build up in the various process streams over time and create problems. For example, high levels of dissolved iron can be toxic to the organisms and stop bio-oxidation. High levels of dissolved ferric ion can also increase electrical consumption costs in valuable metal recovery steps, particularly electrowinning, and contaminate the valuable metal product. Ferric ion is believed to oxidize in the electrolytic cell.

There is therefore a need for a process to remove at least some of the dissolved iron, and specifically dissolved ferric ion and ferric iron compounds, from process streams of valuable metal recovery processes.

### SUMMARY OF THE INVENTION

These and other needs are addressed by the various embodiments and configurations of the present inventions.

In a first invention, a method is provided that includes the steps of:

(a) leaching a valuable metal from a valuable metal- and sulfide-containing material to produce a liquid phase comprising ferric ion and/or ferric oxide and at least one of ferrous ion and ferrous oxide;

(b) passing at least a portion of the liquid phase through one or more nanofiltration membranes to form a retentate and permeate, the retentate having a higher concentration of the ferric ion and/or ferric oxide than the permeate and a lower concentration of the ferrous ion and/or ferrous oxide than the permeate; and

(c) recycling at least a portion of the permeate to step (a).

In a second invention, a method is provided that includes the steps of:

(a) leaching a valuable metal from a valuable metal- and sulfide-containing material to produce a liquid phase comprising ferric ion and/or ferric oxide and ferrous ion and/or ferrous oxide and most of the valuable metal in the material;

(b) recovering from the liquid phase most of the dissolved valuable metal to form a valuable metal product and a barren liquid phase;

(c) passing at least a portion of the barren liquid phase through one or more nanofiltration membranes to form a retentate and permeate, the retentate having a higher concentration of the ferric ion and/or ferric oxide than the permeate and a lower concentration of ferrous ion and/or ferrous oxide than the permeate; and

(d) recycling at least a portion of the permeate to step (a).

In a third invention, a method is provided that includes the steps of:

(a) leaching a valuable metal from a valuable metal- and sulfide-containing material to produce a liquid phase comprising ferric ion and/or ferric oxide and ferrous ion and/or ferrous oxide;

(b) contacting at least a portion of the liquid phase with a bonding agent to bond with the ferric ion and/or ferric oxide while maintaining the ferric ion and/or ferric oxide dissolved in the liquid phase; and

(c) thereafter passing at least a portion of the liquid phase through one or more nanofiltration membranes to form a retentate and permeate, the retentate having a higher concentration of the ferric ion and/or ferric oxide than the permeate and a lower concentration of the ferrous ion and/or ferrous oxide than the permeate; and

(d) recycling at least a portion of the permeate to step (a).

In a fourth invention, a method is provided that includes the steps of:

(a) leaching a valuable metal from a valuable metal- and sulfide-containing material to produce a liquid phase comprising ferric ion and/or ferric oxide and ferrous ion and/or ferrous oxide;

(b) contacting at least a portion of the liquid phase with an oxidant to oxidize at least most of (i) the ferrous ion and/or ferrous oxide and/or (ii) ferric ion while maintaining the oxidized iron and/or iron oxide soluble in the liquid phase; and

(c) thereafter passing at least a portion of the liquid phase through one or more nanofiltration membranes to form a retentate and permeate, the retentate having a higher concentration of ferric iron than the permeate; and

(d) recycling at least a portion of the permeate to step (a).

The present invention(s) can provide a number of advantages depending on the particular configuration. For example, ferric iron concentration during bio-oxidation can be controlled effectively so as to provide relatively high sulfide sulfur oxidation rates. Ferric iron concentration during electrowinning can also be controlled effectively to reduce electrical consumption costs. By converting ferric ion into a compound or complex, operating pressure of the membrane system can be reduced. As will be appreciated, charged spectator ions generally cause a higher osmotic pressure than uncharged compounds.

These and other advantages will be apparent from the disclosure of the invention(s) contained herein.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

As used herein, the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

As used herein, a “precious metal” refers to gold, silver, and the platinum group metals (i.e., ruthenium, rhodium, palladium, osmium, iridium, and platinum).

As used herein, a “valuable metal” refers to a metal selected from Groups 6, 8-10 (excluding iron), 11, and 12 (excluding mercury) of the Periodic Table of the Elements and even more specifically selected from the group including precious metals, nickel, copper, zinc, and molybdenum.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

### BRIEF DESCRIPTION OF THE DRAWINGS

FIG. 1 is a membrane separation system according to an embodiment of the present invention;

FIG. 2 is a flow chart according to an embodiment of the present invention;

FIG. 3 is a flow chart according to an embodiment of the present invention;

FIG. 4 is a diagram of a membrane separation system according to at least one embodiment of at least one of the present inventions showing the results of a 10 liter test solution containing both ferric ion and ferrous ion species fed through the membrane separation system and the resulting retentate and permeate solutions;

FIG. 5 is a diagram of a membrane utilized in at least one embodiment of at least one of the present inventions showing the results of a test solution passed through the membrane and the resulting retentate and permeate solutions;

FIG. 6 is a diagram of a membrane utilized in at least one embodiment of at least one of the present inventions showing the results of a test solution passed through the membrane and the resulting retentate and permeate solutions;

FIGS. 7A and 7B collectively are a table depicting the test results for samples collected over four time points during the experiment shown in FIG. 4; and

FIG. 8 is a chart depicting test results for two feed samples obtained from two separate companies, each of which is shown analyzed prior to nanofiltration (“UF Permeate”) and after nanofiltration (“NF Permeate”).

### DETAILED DESCRIPTION

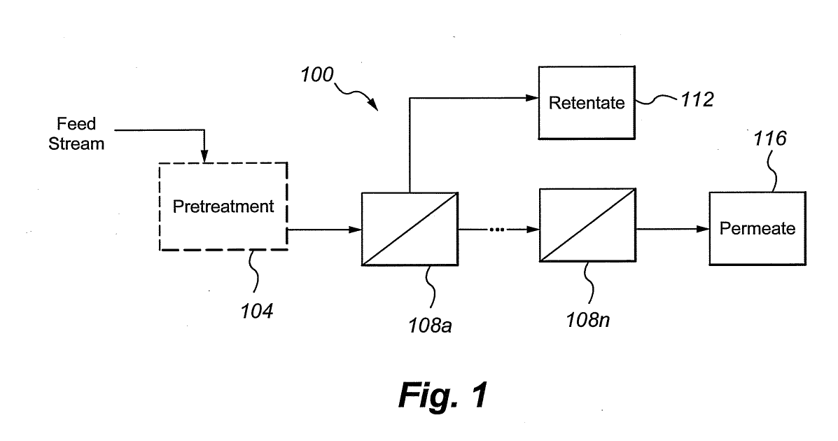

The membrane separation system of FIG. 1 is designed to remove selectively ferric (or trivalent iron) and ferric iron-containing compounds in the retentate while passing ferrous (or divalent iron) and ferrous iron-containing compounds in the permeate. The membrane separation system 100 includes a pretreatment zone 104 and one or more nanofiltration membrane units 108a-n producing a retentate 112 and permeate 116.

The feed stream 104 provided to the membrane separation system 100 is generally all or part of the output produced by oxidation of sulfide sulfur, either by chemical or biological means, and includes a number of dissolved substances. These substances include ferric iron (in a concentration ranging from about 0.05 to about 100 g/L), ferric oxide (in a concentration ranging from about 0.05 to about 100 g/L), ferrous iron (in a concentration ranging from about 0.05 to about 100 g/L), ferrous oxide (in a concentration ranging from about 0.05 to about 100 g/L), sulfuric acid (in a concentration ranging from about 0.05 to about 300 g/L), valuable metal (in a concentration ranging from about 0.005 to about 200 g/L), and various other elements and compounds.

In the pretreatment zone 104, the feed stream 104 can be subjected to various additives.

In one implementation, the feed stream 104 is contacted with one or more oxidants, particularly molecular oxygen. The molecular oxygen can be introduced, such as by sparging in a suitable vessel a molecular oxygen-containing gas through the feed stream. The oxidant can be elements and compounds other than molecular oxygen. The oxidants oxidize ferrous iron to ferric iron and convert ferric ion to ferric oxide. Preferably, at least most and even more preferably at least about 75% of the ferrous ion is oxidized to ferric ion and, after oxidation, at least most and even more preferably at least about 75% of the dissolved iron is in the form of ferric oxide. In this manner, most of the iron, whether originally in the form of ferrous or ferric iron, is removed from the permeate.

In another implementation, the feed stream 104 is contacted with a bonding agent to form a soluble compound and/or complex with ferric ion and ferric oxides, thereby increasing atomic size of the ferric ion or molecular size of the ferric compound, decreasing osmotic pressure, and increasing ferric iron removal rates in the retentate. The bonding agent can be any substance that forms a soluble compound or complex with dissolved ferric ion or ferric compound, does not cause precipitation of the ferric iron, is not an environmentally controlled material, does not bond with dissolved valuable metals, and, in bio-oxidation processes, is not toxic to the bio-oxidizing organisms but preferably stimulates biogrowth. As will be appreciated, osmotic pressure is created by the presence of charged ions in the feed stream; that is, uncharged molecules and complexes in the feed stream do not create an osmotic pressure in the system.

In one formulation, the bonding agent is an element that forms a stable dissolved compound with the ferric ion. The agent can be, for example, a halogen (with chlorine being preferred), arsenic, phosphate, and organic acid (such as citric or acetic). The iron will react with the halogen to form a halide, such as ferric chloride and ferric bromide. In another formulation, the bonding agent is a, preferably polar, compound that forms, under the pH and temperature of the feed stream, a stable compound with ferric ion or a stable complex with a ferric compound. The agent can be, for example, an organic acid (such as a hydroxy acid, a carboxylic acid, tannic acid, and mixtures thereof), a salt of an organic acid, a ligand (a molecule, ion, or atom that is attached to the central atom of a coordination compound, a chelate, or other complex), a chelate (a type of coordination compound in which a central metal ion, such as divalent cobalt, divalent nickel, divalent copper, or divalent zinc, is attached by coordinate links to two or more nonmetal atoms in the same molecule or ligand), ammonia, mineral acids other than sulfuric acid and salts thereof, complexes of the same, and mixtures thereof. Exemplary organic hydroxy and/or carboxylic acids include acetic acid, lactic acid, glycolic acid, caproic acid, citric acid, stearic acid, oxalic acid, and ethylene-diaminetetraacetic acid. The organic acid forms a salt with the ferric ion and a complex with ferric oxide. In either case, the molecular size of the ferric ion or compound, as the case may be, is substantially enlarged by the bonding agent. Ferric iron-containing compounds and complexes from bonding agent addition include, without limitation, ferric acetate, ferric acetylacetronate, ferric-ammonium sulfate, ferric ammonium citrate, ferric ammonium oxalate, ferric ammonium sulfate, ferric arsenate, ferric arsenite, ferric halides, ferric chromate, ferric citrate, ferric dichromate, ferbam, ferric nitrate, ferric oleate, ferric oxalate, ferric phosphate, ferric sodium oxalate, ferric stearate, and ferric tannate.

Preferably, sufficient bonding agent is contacted with the feed stream to form a compound with the fraction of the ferric and/or ferrous ions and/or ferric and/or ferrous compounds to be removed from the feed stream. If, for example, X is the number of moles of ferric ion and/or ferric compound to be removed and if the bonding agent selectively bonds to ferric ion and/or ferric compound, the amount of bonding agent added to the feed stream is preferably at least X, more preferably at least about 125% of X and even more preferably ranges from about 125% of X to about 250% of X.

Preteatment can be performed in a stirred vessel, a baffled conduit (having turbulent flow conditions), an unbaffled conduit, or some other type of containment. Preferably, pretreatment is performed in a conduit. The inventors have determined that, in some applications, the use of oxidants and/or bonding agents can result in the removal of valuable metals from the feed stream and/or retention of valuable metals in the retentate.

The pretreated feed stream is inputted into one or more membrane units 108a-n arranged in parallel or series. Each unit 108a-n can be one or more membranes. Preferably, the membranes are nanofiltration membranes. Typically, a nanofiltration membrane has a molecular weight cutoff in the range of about 500 to 5,000 daltons and even more typically in the range of about 1,000 to about 2,000 daltons; that is, the membrane will normally pass molecules smaller than the molecular weight cutoff. This cutoff range normally equates to a membrane pore size ranging from about 0.001 to about 0.1 microns and even more commonly from about 0.001 to about 0.1 microns. Smaller polar ferric compounds are removed in the retentate due to water molecules forming polar van der Waals bonds with the polar ferric compounds, thereby effectively increasing the size of the molecule above the cutoff. The membrane is commonly formed of a polymeric material. Particularly preferred membranes are hollow fiber or spiral wound membranes formed of urea formaldehyde or Bakelite, with the G5 to G20 nanofiltration membranes manufactured by GE being even more preferred. The G5 can separate ferric ion (in the retentate) from ferrous ion (in the permeate) and the G10 can separate ferric oxide (in the retentate) from ferrous oxide (in the permeate). The G20 can separate ferric (organic) complexes (in the retentate) from ferrous ions and compounds (in the permeate).

In one configuration, the membranes 108a-n are arranged in series, with a first membrane unit 108 removing in the retentate ferric oxide or ferric ion and passing in the permeate to a second membrane unit 108 that removes in the retentate the other of ferric oxide or ferric ion.

The retentate 112 preferably includes a higher concentration of ferric ion, ferric compounds, and ferric complexes than the permeate 116. In one configuration, the membrane units 108a-n remove, in the retentate 112, an amount of ferric iron from the feed stream that is at least the amount produced during sulfide sulfur oxidation; in this manner, buildup of ferric iron in the system is inhibited. In another configuration, the membrane units 108a-n remove, in the retentate 112, at least most, and even more preferably at least about 75% of the ferric iron from the feed stream. In both configurations most of the ferrous iron, sulfuric acid, and other monovalent and divalent ions (including monovalent and divalent valuable metal ions) commonly passes through the membrane units 108 in the permeate 116.

When the feed stream includes dissolved valuable metals, membrane separation is performed so as to remove preferably no more than about 25%, even more preferably no more than about 10%, and even more preferably no more than about 5% of the valuable metal to the retentate 112. Stated another way, the permeate 116 preferably includes at least about 75%, more preferably at least about 90%, and even more preferably at least about 95% of the valuable metal in the feed stream. Where the valuable metal is divalent, it is desirable to pass the ferrous iron through the membrane separation in the permeate to avoid inadvertent removal of the valuable metal in the retentate.

The retentate is commonly only a minority portion of the feed stream. More commonly, the retentate 116 constitutes at most about 35 vol. % of the feed stream and even more commonly at most about 25 vol. % of the feed stream, with about 10 vol. % or less being even more common.

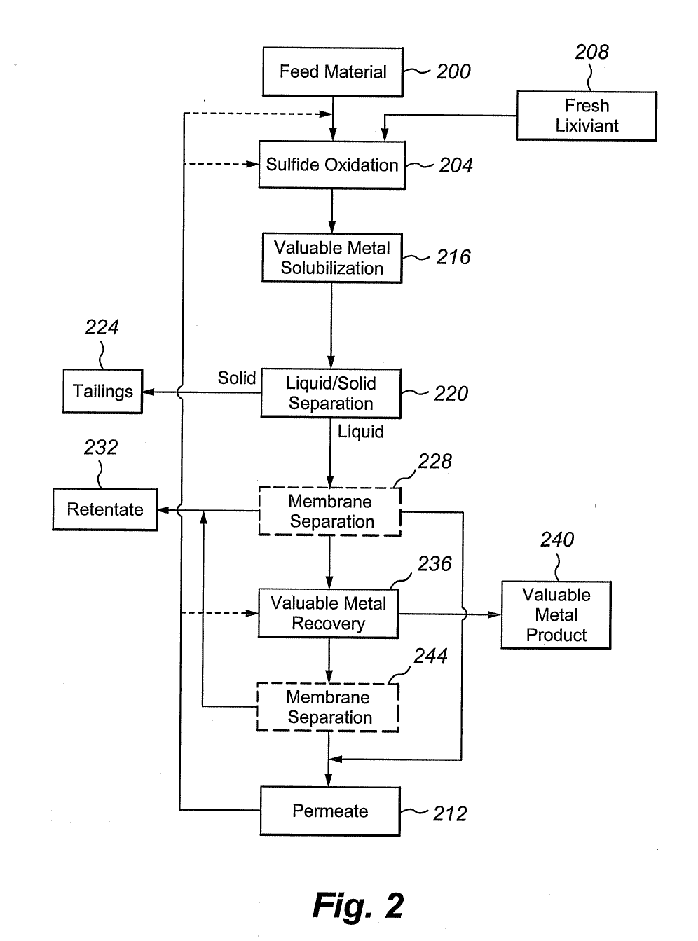

A first valuable metal recovery process will be discussed with reference to FIG. 2. This process is particularly useful for valuable base metals.

A feed material 200, which is a valuable metal-containing, sulfidic material, such as ore, concentrate, and/or tailings, is comminuted (not shown) to an appropriate size range and subjected to sulfide oxidation in step 204. Sulfide bio-oxidation can occur in a heap on an impervious leach pad or in a suitable stirred and aerated vessel. Sulfide chemical oxidation can occur in a pressure vessel, such as an autoclave.

The material 200 is contacted with molecular oxygen and fresh lixiviant 208 and recycled permeate 212. The fresh lixiviant 208 and recycled permeate 212 preferably comprises sulfuric acid and has a pH of no more than about pH 2.5.

When sulfide sulfur is bio-oxidized, the following bacteria have been found to be useful:

Group A: Thiobacillus ferroxidans; Thiobacillus thiooxidans; Thiobacillus organoparus; Thiobacillus acidophilus;

Group B: Leptospirillum ferroxidans;

Group C: Sulfobacillus thermosulfidooxidans;

Group D: Sulfolobus acidocaldarius, Sulfolobus BC; Sulfolobus solfataricus and Acidianus brierleyi and the like.

These bacteria are further classified as either mesophiles (Groups A and B) i.e. the microorganism is capable of growth at mid-range temperatures (e.g. about 30 degrees Celsius) and facultative thermophiles (Group C) (e.g. about 50 to 55 degrees Celsius); or obligate thermophiles (Group D) which are microorganisms which can only grow at high (thermophilic) temperatures (e.g. greater than about 50 degrees Celsius). For Group A. and B bacteria the useful temperatures should not exceed 35 degrees Celsius; for Group C. bacteria these temperatures should not exceed 55 degrees Celsius; and for Group D. bacteria the temperature should not exceed 80 degrees Celsius.

The lixiviant may include nutrients and additional organisms to inoculate the feed material with additional and/or different bacteria. The lixiviant can include from about 1 to about 10 g/l ferric sulfate to aid in valuable metal dissolution. The lixiviant can also include an energy source and nutrients for the microbes, such as iron sulfate, ammonium sulfate, and phosphate.

During sulfide sulfur oxidation, the sulfuric acid in the lixiviant 208 and recycled permeate 212 and produced during oxidation dissolves (step 204) the valuable (base) metal from the feed material into the liquid phase.

In the liquid/solid phase separation step 220, the liquid phase, or pregnant leach solution, is separated from the solid phase. After oxidation is completed, the solid phase is disposed of as tailings 224.

The pregnant leach solution, which contains most of the valuable base metals in the feed material as dissolved ions and species, or a portion thereof, is subjected to optional membrane separation step 228 using membrane system 100. Care should be taken to avoid removing dissolved valuable metals in the retentate 232.

The pregnant leach solution (in the event that step 228 is not performed) or permeate (in the event that step 228 is performed) is subjected to valuable metal recovery in step 236 to form a valuable metal product 240. Valuable metal recovery may be performed by any suitable technique, with direct electrowinning and solvent extraction/electrowinning being preferred.

The barren solution from valuable metal recovery (which may be a raffinate or barren leach solution) or a portion thereof is subjected to optional membrane separation step 244 to produce permeate 212 and retentate 232. The permeate 212 is recycled to one or more of the locations shown.

In the permeate 212 recycle in a bio-oxidation process, a sufficient amount of ferric ion is removed to provide a ferric ion concentration in the combined fresh lixiviant 208 and recycled permeate 212 of preferably no more than about 30 grams per liter. Thereafter, iron may start to affect the reaction rate because of inhibitory effects on the bacteria. Because arsenic is a biocide and is normally removed with ferric iron, sufficient ferric iron is preferably removed to maintain the amount of arsenic to a level of no more than about 14 grams per liter.

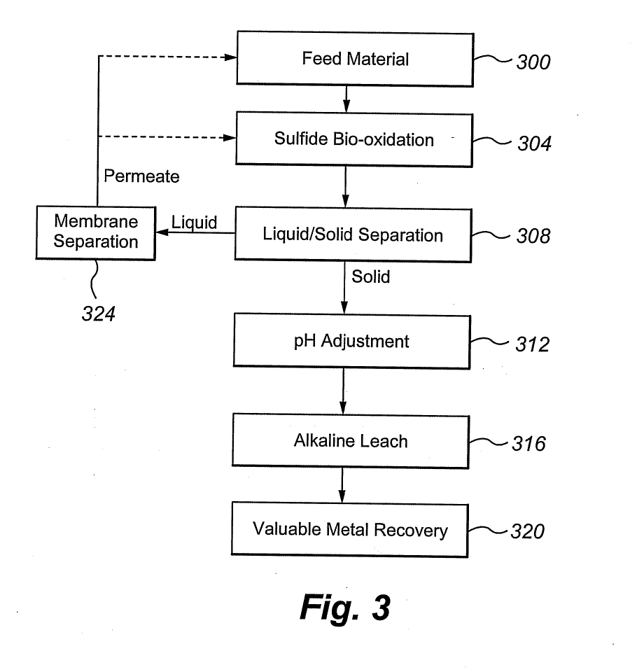

A further valuable metal recovery process will be discussed with reference to FIG. 3. This process is particularly useful for valuable precious metals.

A feed material 300, which is a valuable precious metal-containing, sulfidic material, such as ore, concentrate, and/or tailings, is comminuted (not shown) to an appropriate size range and subjected to sulfide bio-oxidation in step 304. Sulfide bio-oxidation can occur in a heap on an impervious leach pad or in a suitable stirred and aerated vessel. In contrast to step 204, when the valuable metal is a precious metal, the precious metal remains in the solid-phase.

In step 308, the solid-phase residue is separated from the liquid-phase.

The separated liquid-phase is subjected to membrane separation in step 324, and the permeate recycled to the process locations shown.

In step 312, the solid-phase residue is subjected to pH adjustment, such as by counter current decantation, to consume residual acid and ferric sulfates.

In step 316, the pH adjusted solid-phase residue is subjected to an alkaline leach, using alkaline lixiviants such as cyanide, to dissolve valuable precious metals into the liquid phase.

In step 320, the liquid-phase, which now contains most of the precious metals, is subjected to valuable metal recovery.

Additional objects, advantages, and novel features of this invention will become apparent to those skilled in the art upon examination of the following examples thereof, which are not intended to be limiting.

### EXAMPLES

### Example 1

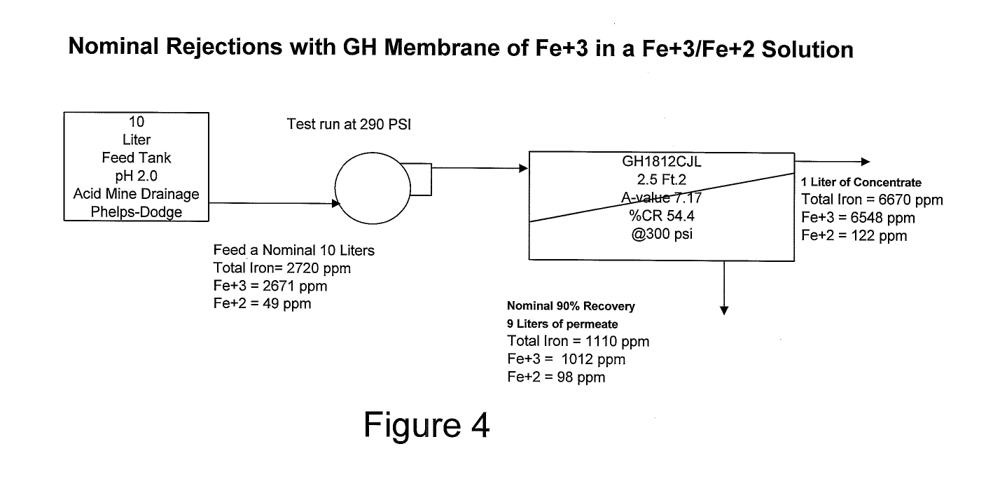

In order to test the efficacy of the membrane separation system utilized with at least one embodiment of at least one of the present inventions with respect to the selective retention of ferric (or trivalent iron) and ferric iron-containing compounds in the retentate and with respect to the passing of ferrous (or divalent iron) and ferrous iron-containing compounds in the permeate, a test run of the membrane separation system was performed as shown in FIG. 4. A 10 liter test solution of an acid mine drainage solution obtained from the Phelps Dodge Corporation (Phoenix, Ariz.) containing a total iron concentration of 2,720 parts per million (ppm), of which 2,671 ppm were ferric species and 49 ppm were ferrous species, at a pH of 2.0 was placed into a 10 liter feed tank and fed into the membrane separation system at a pressure of about 290 pounds per square inch (PSI). The test solution was passed through a GH1812CJL Nanofiltration Membrane (HW Process Technologies, Inc.) that had a 2.5 square foot surface area, a water permeation rate of the membrane (A-value) of 7.17, a conductivity reduction or removal value (% CR) of 54.4 and was maintained at a pressure of about 300 PSI. As the test solution was passed through the membrane, the retentate was collected and returned to the point of entry into the solution until such time as ninety percent (90%) of the original test solution had passed through the membrane as permeate. With each pass of the retentate through the system, the total volume of the retentate decreased, causing the retentate to become more concentrated, and the total volume of the permeate increased as the ferrous ion species were removed from the retentate over time.

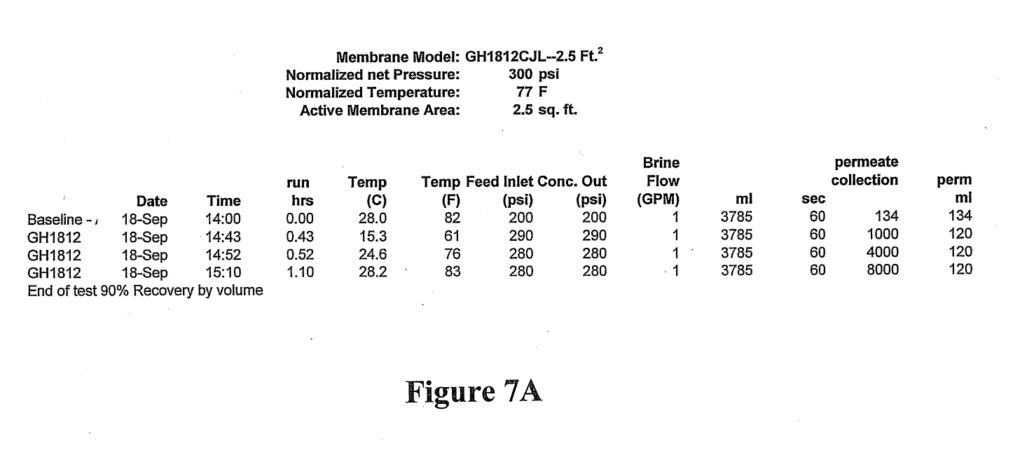

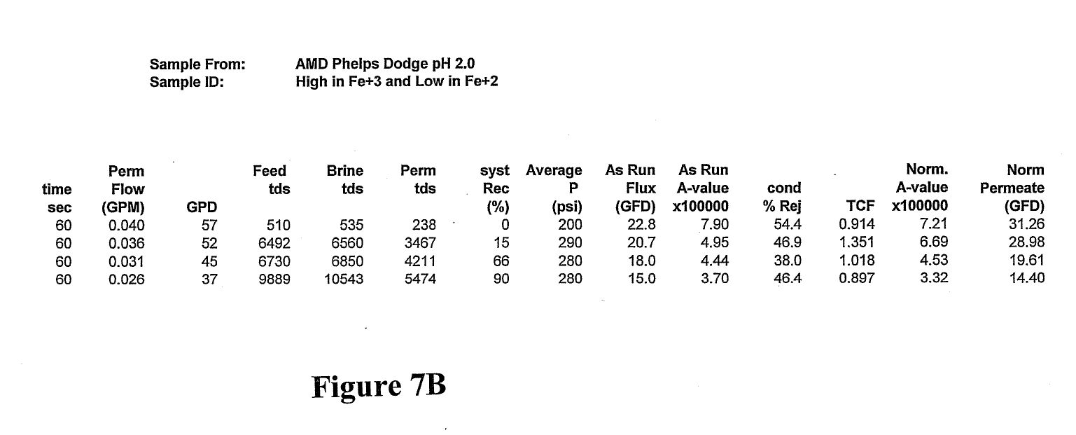

A table depicting the test results during the test run is included as FIG. 7. Four separate samples were taken and analyzed during the test run, which took approximately two hours, each sample being collected over a 60-second period. At each time point the total dissolved solutes (tds) was determined for the test solution (Feed), the retentate (Brine) and the permeate (Perm). Additionally, at each time point the system recovery (syst Rec %) was calculated based on the tds determinations of the three solutions, and the permeation rate of the membrane was determined (A-values). The test run was performed at medium pressure, as shown in the column labeled “Average P (psi).” The time point results depicted in FIGS. 7A and 7B show that the total dissolved solutes increased with each pass of the retentate through the system. This was expected as the membrane filtered out the ferric ion species with each pass and allowed additional ferrous species and valuable metals to pass through with each pass. The results also indicate that the permeation rate of the membrane decreased over time during the test run, as the A-value of the membrane decreased. This was due to membrane fouling as the ferric ion species, which were not allowed to pass, began to clog the membrane over time.

As shown in FIG. 4, at the end of the test run, the membrane filtration yielded 1 liter of concentrated retentate and 9 liters of permeate, thereby showing that the membrane separation system was capable of returning 90% of the original test solution as permeate. Both the retentate and the permeate were tested to determine the iron concentration in each solution. The retentate included a total iron concentration of 6,670 ppm iron, of which 6,548 ppm was ferric species and the remaining 122 ppm were ferrous species. The permeate included a total iron concentration of 1,110 ppm of iron, of which 1,012 ppm was ferric species and the remaining 98 ppm was ferrous species. The results indicate that the membrane separation system utilized is capable of providing a 90% yield of permeate with a feed solution and that it serves to selectively retain ferric (or trivalent iron) and ferric iron-containing compounds in the retentate and to pass ferrous (or divalent iron) and ferrous iron-containing compounds with the permeate.

### Example 2

In order to test the efficacy of the nanofiltration membranes utilized with at least one embodiment of at least one of the present inventions with respect to the selective removal of iron, ferric and/or ferrous species from a solution containing valuable metals, two test experiments were run. In the first experiment, a test solution containing 38 g/L copper, 1.14 g/L iron, and 0.6 g/L cobalt at low pH was passed through a G-8 Nanofiltration Membrane (HW Process Technologies, Inc.) with a 700 dalton molecular weight cutoff at a flow rate of 63 gallons per minute. In the second experiment, the same test solution (containing 38 g/L copper, 1.14 g/L iron, and 0.6 g/L cobalt at low pH) was passed through a GH Nanofiltration Membrane (HW Process Technologies, Inc.) with a 700 dalton molecular weight cutoff at a flow rate of 63 gallons per minute.

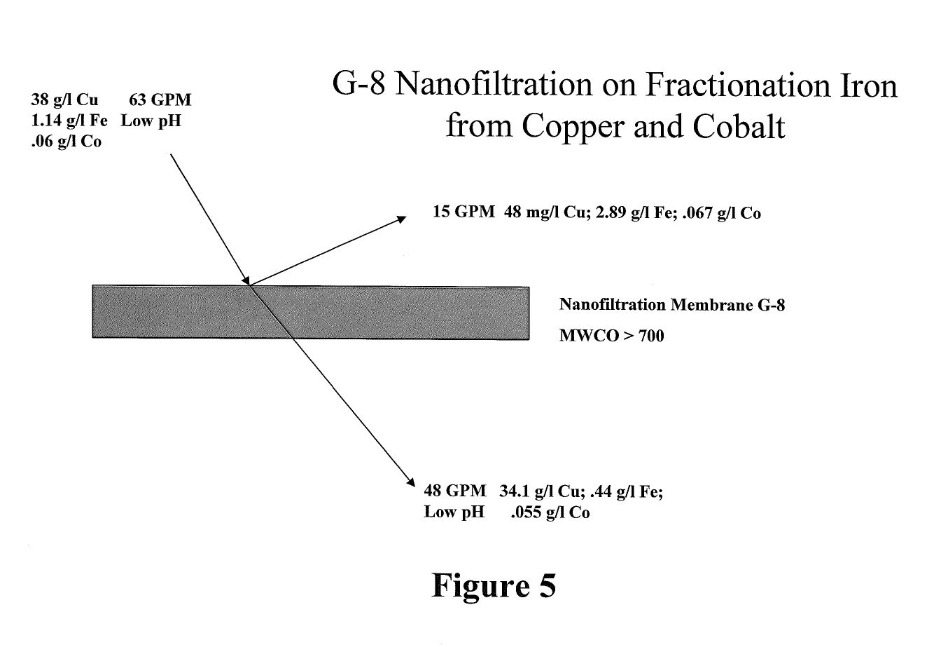

The results of the first experiment are shown in FIG. 5. After filtration with the G-8 Nanofiltration Membrane, the permeate and the retentate were tested to determine their composition with respect to copper, iron and cobalt. As shown in FIG. 5, the permeate liquid that passed through the G-8 Nanofiltration Membrane contained 34.1 g/L copper, 0.44 g/L iron, and 0.055 g/L cobalt at low pH and the flow rate was 48 gallons per minute. The retentate solution that did not pass through the Membrane contained 48 mg/L copper, 2.89 g/L iron, and 0.067 g/L cobalt in a solution that had a flow rate of 15 gallons per minute. The significant increase in the concentration of iron in the retentate is because the retentate solution was merely a fraction of the total solution input through the Membrane, thereby making the iron significantly more concentrated in the retentate solution. The results indicate that the G-8 Nanofiltration Membrane successfully filtered out the iron in the test solution while allowing the valuable metal, in this case copper, to pass through.

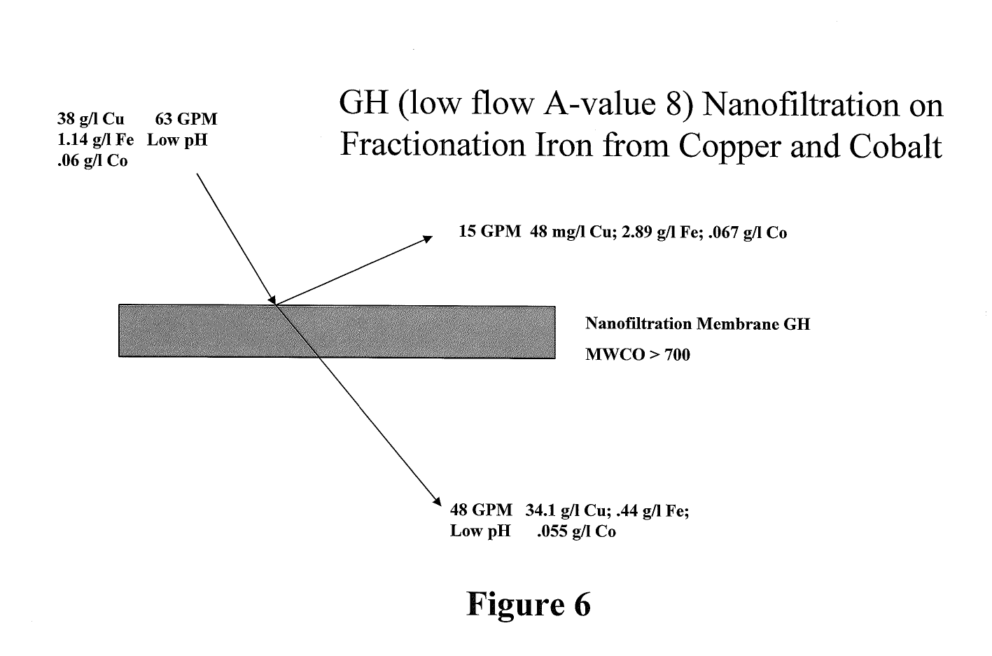

The results of the second experiment are shown in FIG. 6. After filtration with the GH Nanofiltration Membrane, the permeate and the retentate were tested to determine their composition with respect to copper, iron and cobalt. As shown in FIG. 6, the permeate liquid that passed through the GH Nanofiltration Membrane contained 34.1 g/L copper, 0.44 g/L iron, and 0.055 g/L cobalt at low pH and the flow rate was 48 gallons per minute. The retentate solution that did not pass through the Membrane contained 48 mg/L copper, 2.89 g/L iron, and 0.067 g/L cobalt in a solution that had a flow rate of 15 gallons per minute. As with the first test, the significant increase in the concentration of iron in the retentate is because the retentate solution was merely a fraction of the total solution input through the Membrane, thereby making the iron significantly more concentrated in the retentate solution. The results of this second test mirror those from the first test in that they indicate that the GH Nanofiltration Membrane successfully filtered out the iron in the test solution while allowing the valuable metal, in this case copper, to pass through.

### Example 3

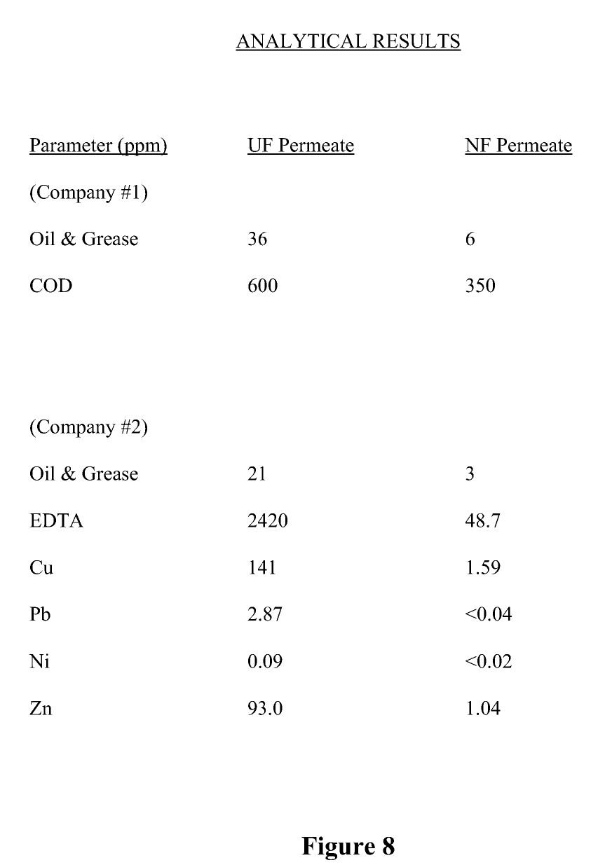

In order to test whether a nanofiltration membrane utilized in accordance with at least one embodiment of at least one of the present inventions is capable of preventing a bonding agent (an element that forms a stable dissolved compound with ferric ion species) from passing, thereby retaining the bonding agent in the retentate, two test experiments were run. In the first experiment, an untreated effluent feed sample containing oil, grease, and several dissolved solutes that generated a total chemical oxygen demand (COD) of 600 ppm was obtained from Company #1 and passed through a nanofiltration membrane. In the second experiment, an untreated effluent feed sample containing oil, grease, ethylene-diaminetetraacetic acid (EDTA), copper, lead, nickel and zinc was obtained from Company #2 and passed through a nanofiltration membrane. The results are shown in FIG. 8. The sample from Company #2 was particularly useful as EDTA is a commonly known chelating agent and is thus capable of being used as one of the bonding agents contemplated in the present inventions. As shown in FIG. 8, “UF Permeate” refers to the untreated feed sample, “NF Permeate” refers to the resulting solution collected upon passing of the feed sample through the nanofiltration membrane, “COD” refers to total chemical oxygen demand, “Cu” refers to copper, “Pb” refers to lead, “Ni” refers to nickel and “Zn” refers to zinc. All values shown are in parts per million (ppm).

The results for the feed sample obtained from Company #1 show that the nanofiltration membrane was able to repel, or prevent from passing, 30 ppm of the oil and grease as well as 250 ppm of the total COD species in the feed sample. This revealed that the nanofiltration membrane was capable of preventing several chemical species from passing into the permeate, though the precise composition of the COD species was not determined.

The results for the feed sample obtained from Company #2 show that the nanofiltration membrane was able to repel all but 48.7 ppm of the original 2,420 ppm of EDTA present in the feed sample, in addition to the other species that were prevented from passing into the permeate. This result shows that the nanofiltration members utilized in the present inventions is capable of preventing a commonly known bonding agent, EDTA, from passing.

A number of variations and modifications of the invention can be used. It would be possible to provide for some features of the invention without providing others.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. The features of the embodiments of the invention may be combined in alternate embodiments other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations, combinations, and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method, comprising:
(a) leaching a valuable metal from a valuable metal- and sulfide-containing material to produce a liquid phase comprising at least one of ferric ion and ferric oxide and at least one of ferrous ion and ferrous oxide;
(b) passing at least a portion of the liquid phase through one or more nanofiltration membranes to form a retentate and permeate, the retentate having a higher concentration of the at least one of the ferric ion and ferric oxide than the permeate and a lower concentration of the at least one of the ferrous ion and ferrous oxide than the permeate; and
(c) recycling at least a portion of the permeate to step (a).

2. The method of claim 1, wherein the liquid phase comprises most of the valuable metal in the material and further comprising:
(d) recovering at least most of the valuable metal from the liquid phase to form a valuable metal product and a barren liquid phase, wherein the at least a portion of the liquid phase in step (b) is at least a portion of the barren liquid phase.

3. The method of claim 1, wherein the liquid phase comprises most of the valuable metal in the material and wherein the at least a portion of the liquid phase in step (b) is at least a portion of the liquid phase before recovery of valuable metal therefrom.

4. The method of claim 1, wherein the valuable metal is a precious metal, wherein the solid phase comprises most of the valuable metal after step (a), and wherein the liquid phase comprises, at most, only a small portion of the valuable metal.

5. The method of claim 1, wherein step (b) comprises the sub-steps:
(B1) contacting the at least a portion of the liquid phase with a bonding agent to bond with the at least one of the ferric ion and ferric oxide while maintaining the at least one of the ferric ion and ferric oxide dissolved in the liquid phase; and
(B2) thereafter passing the at least a portion of the liquid phase through the one or more nanofiltration membranes to form the retentate and permeate.

6. The method of claim 5, wherein the bonding agent is at least one of a halogen, phosphate, and organic acid.

7. The method of claim 5, wherein the bonding agent is at least one of an organic acid, a salt of an organic acid, a ligand, a chelate, ammonia, a mineral acid other than sulfuric acid, a salt of a mineral acid other than sulfuric acid, and complex.

8. The method of claim 7, wherein the bonding agent is at least one of a hydroxyl and carboxylic organic acid.

9. The method of claim 3, wherein no more than about 25% of the dissolved valuable metal in the at least a portion of the liquid phase is removed in the retentate.

10. A method, comprising:
(a) leaching a valuable metal from a valuable metal- and sulfide-containing material to produce a liquid phase comprising at least one of ferric ion and ferric oxide and at least one of ferrous ion and ferrous oxide and at least most of the valuable metal in the material;
(b) recovering from the liquid phase at least most of the dissolved valuable metal to form a valuable metal product and a barren liquid phase;
(c) passing at least a portion of the barren liquid phase through one or more nanofiltration membranes to form a retentate and permeate, the retentate having a higher concentration of the at least one of the ferric ion and ferric oxide than the permeate and a lower concentration of the at least one of the ferrous ion and ferrous oxide than the permeate; and
(d) recycling at least a portion of the permeate to step (a).

11. The method of claim 10, wherein step (c) comprises the sub-steps:
(C1) contacting the at least a portion of the liquid phase with a bonding agent to bond with the at least one of the ferric ion and ferric oxide while maintaining the at least one of the ferric ion and ferric oxide dissolved in the liquid phase; and
(C2) thereafter passing the at least a portion of the liquid phase through the one or more nanofiltration membranes to form the retentate and permeate.

12. The method of claim 11, wherein the bonding agent is at least one of a halogen, phosphate, and organic acid complex.

13. The method of claim 11, wherein the bonding agent is at least one of an organic acid, a salt of an organic acid, a ligand, a chelate, ammonia, a mineral acid other than sulfuric acid, a salt of a mineral acid other than sulfuric acid, and complex.

14. The method of claim 13, wherein the bonding agent is at least one of a hydroxyl and carboxylic organic acid.

15. The method of claim 11, wherein no more than about 10% of the dissolved valuable metal in the at least a portion of the liquid phase is removed in the retentate.

16. A method, comprising:
(a) leaching a valuable metal from a valuable metal- and sulfide-containing material to produce a liquid phase comprising at least one of ferric ion and ferric oxide and at least one of ferrous ion and ferrous oxide;
(b) contacting at least a portion of the liquid phase with a bonding agent to bond with the at least one of the ferric ion and ferric oxide while maintaining the at least one of the ferric ion and ferric oxide dissolved in the liquid phase; and
(c) thereafter passing at least a portion of the liquid phase through one or more nanofiltration membranes to form a retentate and permeate, the retentate having a higher concentration of the at least one of the ferric ion and ferric oxide than the permeate and a lower concentration of the at least one of the ferrous ion and ferrous oxide than the permeate; and
(d) recycling at least a portion of the permeate to step (a).

17. The method of claim 16, wherein the liquid phase comprises most of the valuable metal in the material and further comprising:
(e) recovering at least most of the valuable metal from the liquid phase to form a valuable metal product and a barren liquid phase, wherein the at least a portion of the liquid phase in step (b) is at least a portion of the barren liquid phase.

18. The method of claim 16, wherein the liquid phase comprises most of the valuable metal in the material and wherein the at least a portion of the liquid phase in step (b) is at least a portion of the liquid phase before recovery of valuable metal therefrom.

19. The method of claim 16, wherein the valuable metal is a precious metal, wherein the solid phase comprises most of the valuable metal after step (a), and wherein the liquid phase comprises, at most, only a small portion of the valuable metal.

20. The method of claim 16, wherein the bonding agent is at least one of a halogen, phosphate, and organic acid.

21. The method of claim 16, wherein the bonding agent is at least one of an organic acid, a salt of an organic acid, a ligand, a chelate, ammonia, a mineral acid other than sulfuric acid, a salt of a mineral acid other than sulfuric acid, and complex.

22. The method of claim 21, wherein the bonding agent is at least one of a hydroxyl and carboxylic organic acid.

23. The method of claim 16, wherein no more than about 25% of the dissolved valuable metal in the at least a portion of the liquid phase is removed in the retentate.

24. A method, comprising:
(a) leaching a valuable metal from a valuable metal- and sulfide-containing material to produce a liquid phase comprising at least one of ferric ion and ferric oxide and at least one of ferrous ion and ferrous oxide;
(b) contacting at least a portion of the liquid phase with an oxidant to oxidize at least most of (i) the at least one of the ferrous ion and ferrous oxide and/or (ii) ferric ion while maintaining the oxidized iron and/or iron oxide soluble in the liquid phase; and
(c) thereafter passing at least a portion of the liquid phase through one or more nanofiltration membranes to form a retentate and permeate, the retentate having a higher concentration of ferric iron than the permeate; and
(d) recycling at least a portion of the permeate to step (a).
